(19) United States
(12) Patent Application Publication
(10) Pub. No.: US 2016/0063650 A1
(43) Pub. Date: Mar. 3, 2016

(54) AUGMENTING CORPORATE IDENTITY WITH DATA FROM PUBLIC SOCIAL NETWORKS

(71) Applicant: Microsoft Corporation, Redmond, WA (US)

(72) Inventor: Sharon Laivand, Netanya (IL)

(21) Appl. No.: 14/474,293

(22) Filed: Sep. 1, 2014

(51) Int. Cl. G06Q 50/00; H04L 29/08; G06Q 10/10

(52) U.S. Cl. CPC G06Q 50/01; G06Q 10/10; H04L 67/306

(57) ABSTRACT

Disclosed herein is a system and method for augmenting a corporate profile of a user on a private social network with profile information from at least one public social network. Once the profiles have been integrated groups associated with the private social network are analyzed to determine if there are groups that the user should belong to based on a similarity between their profile features and the membership features of each of the groups. The groups may be internal to the private social network or may be hosted by a public social network. Users may be removed from the groups as well based on changes in their profiles.

### TECHNICAL FIELD

This description relates generally to the augmentation of a corporate or private profile on a private social network with profile information from public social networks.

### BACKGROUND

Many business and other entities maintain their own private social networks. These private social networks allow for the users and employees to communicate in a social manner about their work and other assignments. Some corporations also maintain groups for employees to participate in that are outside the scope of the daily work. However, knowing about these groups and finding these groups is sometimes difficult for employees. Further in the context of a private social network the corporate identity of the employee is all that the system has to go on in helping or assisting the employee in finding these groups.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a system and method for assisting a private social network in identifying groups for employees and users to join based on corporate identity and their identity from public social networks. The system starts with the persons corporate profile and then reaches out to any number of public social networks to obtain the user's profile information from those sites. This information is then added to the corporate profile to create an enhanced version of the profile combining the profile information from both the private and public networks. Based on the features in the profiles the system can then analyze its groups and determine if there are membership features of the group that match the features of the individuals. If there is a match the user can be added to the group or can be prompted to join the group. Similarly when a change in a profile is detected the system can look again at the groups and see if there are new groups for the user to join or if the user needs to be removed from a group because their features no longer match.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram illustrating components of the system for incorporating public social network 110 data with data associated with a corporate identity according to one illustrative embodiment.

FIG. 2 is a flow diagram illustrating an exemplary approach for generating a profile for an employee and associating them with the proper groups in an organization.

FIG. 3 illustrates a component diagram of a computing device according to one embodiment.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable storage medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. This is distinct from computer storage media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media and not with computer readable storage media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

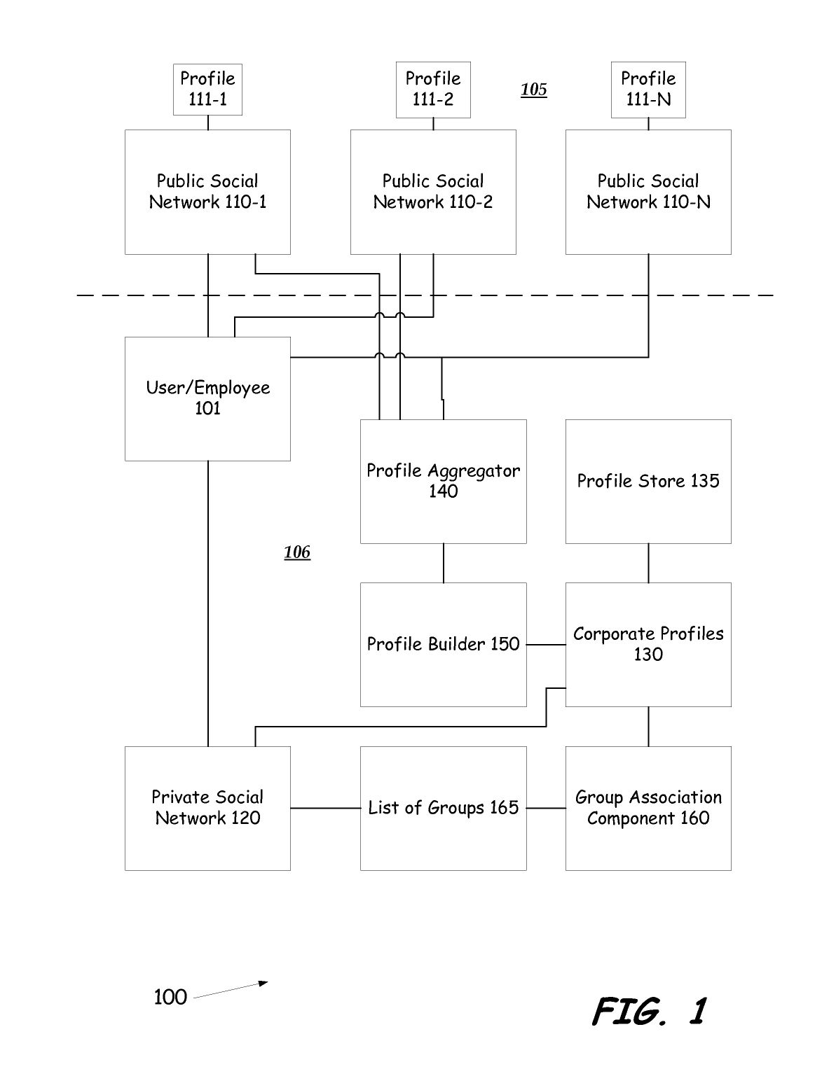

FIG. 1 is a block diagram illustrating components of the system for incorporating public social network 110 data with data associated with a corporate identity according to one illustrative embodiment. While FIG. 1 discusses one approach for the system, the various implementations discussed herein may be combined with one another to form different implementations and presentations of the system.

System 100 includes at least one user 101, a public network side 105, a private network side 106, public social networks 110 110-1, 110-2, 110-N (collectively social network 110 or public social network 110 110), private social network 120, corporate profile 130, profile aggregator 140, profile builder 150 and group association component 160.

Public network side 105 is a portion of a network that is exposed and accessible to the general public. The public network can, for example, include the internet, interweb, open networks that are hosted by companies, business or other entities that allow individuals to freely navigate and access the information contained thereon. The public network side can include applications and websites that individuals can access without any restrictions placed on the access to. Some of these applications may require or use information to uniquely identify an individual or user. However, typically the applications and websites are open to any person or entity in the world to join and access.

In contrast to the public network side, the private network side 106 is a network that is closed from access by the general public. Typically, this type of network is associated with private corporations. Users may access the private network from the public network through the use of secure protocols and identity managers, such as through a virtual private network (VPN) and the user of an identity chip in an ID badge. The private network side hosts a number of applications that a specific to the corporation. These applications are applications that handle, for example, payroll, human resources, policies, products, product development, etc. Further, these applications can include websites and other internal resources that are needed for the employees to successfully complete and manage their jobs. Additionally, many corporations have internal groups that handle various activities for their respective employees. These groups can include, for example, email or distribution lists for various teams or groups that perform certain functions for the corporation or may include groups that have been formed to encourage the social well-being of the employees, such as groups related to hobbies or sports. Some of these private groups may also have a presence on the public network side, but the ability for the employees to find these groups may be difficult or impossible due to certain privacy settings or permissions added to the groups on the public network side.

User 101 is in one embodiment an employee of a corporation. User 101 may be referred to as employee or individual herein as well. However, user 101 can be any person or entity that has a profile that exists in a private network that does not freely share its information with public networks. User 101 may also have a number of profiles that exist on both the public networks and the private network. However, as each of these profiles exists on their own, the ability to use this information on the private network side is generally limited.

Social networks 110 are a social network products and application that allow the user to connect with various other people and organizations that the user either knows or has an interest in. Public social networks 110 include networks such as Facebook, Twitter, Yammer, Google+, Google Hangout, Instagram, Pintrest, LinkedIn, etc. These social networks are hubs where the user can interact with their “friends”, share interests with their friends, discuss topics of the day, simply share an idea, etc. Also within these public social networks 110 users are able to become “friends” with people who they may not have known previously but have a shared interest, such as a shared interest in dancing, eating haggis, a particular sports team, profession, etc. On each of the public social networks 110 the user 101 has a corresponding user profile 111. This user profile 111 can include information related to the user's interests, activities, hobbies, friends, groups that the user belongs to, etc. on that particular social network. However, because the user may have more than one profile on more than one public social network 110 the ability to have a single profile for the user across all of the various social networks is extremely difficult to achieve. Often times a user may actually desire to keep the profiles separate from each other, such as when the user has a “Business Profile” on a site such as LinkedIn where the user wants to ensure that they only share business or professional information with others, and a “Personal Profile” on a site such as Facebook or Twitter where the user wants to share more personal information with others. In some instances the user may have two accounts or profiles on the same social network site to allow for different types of communication with their networks. (e.g. a professional Twitter account and a personal Twitter account).

Private social network 120 is in one embodiment a social network that is created and maintained by a private organization solely for its employees and organization. In some embodiments the private social network 120 is a social network that has been developed by the organization for its own use. As such the private social network 120 may include features that are specific to the organization that is using it. For example, the private social network 120 may have ways of communicating with members that are unique to the organization or leverages tools that the organization already uses. In other embodiments these private social network 120s maybe based upon, or even run by the same social networks as found on the public side. In some embodiments the unique tools of the organization may be incorporated into the public provider's system. The private social network 120 allows for the company to create groups for employees to join and also allows for the employees to share information about the work environment without any worry that the information contained on the private network would be shared outside the confines of the organization. The private social network 120 may also have groups that are unrelated to the activities of the employer, but are created and exist on the private social network 120 to improve moral or allow for individuals with similar outside interests to connect. (e.g. groups dedicated to hobbies, sports, etc.).

Corporate profile component 130 is a component of the system that maintains the profiles for each employee or entity of the corporation. Each employee has a profile that is stored in the corporate profile component 130. The employee's corporate profile 130 may initially be created by an administrator, such as an administrator from a human resources department of the company. This profile information is entered into the user's profile and may include information that the employee provided during an employment application process. Additional information may be provided to the corporate profile 130 by other individuals who have contact with the particular employee, such as managers and bosses who may add additional information to the corporate profile 130 related to the role the employee has with the organization. This forms the employee's initial profile. The initial profile is stored in the profile store 135 along with the profiles of the other employees. Profile store 135 may be any type of storage system that can store profile information of individuals. Each employee has their profile stored as a separate profile from each other.

The profiles of the employees may be further enhanced by the incorporation of data and information from the employees' public social network 110 profiles. The profile aggregator 140 is a component of the system that has the ability to reach out into the public social networks 110 and obtain profile information for each of the employees who are members of the organizations. The profile aggregator 140 may receive from the employees an indication of the social networks that they belong to. The employees may provide to the profile aggregator 140 the information required to access their profiles from the public social network 110. Some social networks allow for the access of this information from application programming interfaces (API). Some social networks require the user to grant permission to the accessing site prior to allowing the accessing site to use the information of the user's profile. Once the appropriate access has been given to the social network the profile aggregator 140 accesses the profile information from each of the sites. This profile information is stored by the profile aggregator 140 in a manner that allows for the profile builder 150 to use the information contained therein in building the profile for the user/employee 101.

The profile builder 150 is a component of the system that creates a unified profile on the corporate network for each of the employees based on the information available from the public social networks 110. The profile builder 150 takes the profile information that was obtained from the profile aggregator 140 and begins a process for determining information about the employee as well understanding the employee's personal preferences. The profile builder 150 identifies various data points about the employee that are useful in the building of the profile for the employee on the private social network 120. The profile builder 150 can use any process available to identify the data points in the employee's profile. These data points may be people the employee follows, sites they have liked, interests that they have shown, groups they belong to, check-in locations, where they have lived, where they live, familial status, etc. Profile builder 150 then accesses the employee's corporate profile 130 and augments the corporate profile 130 with the information that was determined from the public social networks 110. This may include for example adding the employee's interests to the corporate profile 130, information related to where they have lived, family status, interests, hobbies, etc. Again any method may be used by the profile builder 150 to add this information to the corporate profile 130 of the employee. The now augmented or enhanced corporate profile 130 is stored for use by private social network 120 in a profile store 135.

Group association component 160 is a component of the system that is configured to analyze the various corporate profiles 130 and identify groups in the private social network 120 that the employee should belong to. As the private social network 120 has a number of groups that are related to the company the ability to identify the employees who should belong to those groups is important to the success of the private social network 120. These groups are contained in a list of groups 165 162 maintained by the group association component 160. Each of the groups that are in the private social network 120 includes information that identifies the features of the members of the group, or membership features. This information is information that is contained in the profiles of the employees. For some groups this information is related to the role the employee plays in the organization. For example, if the employee is a manager, then groups related to managers would be groups the employee should be a member. In this instance the group association component 160 can automatically add the identified employee to the group when a match with a group is found. In another example, the private social network 120 hosts groups that are related to interests of the various employees. These groups are maintained in the private social network 120 to, for example, build moral among the employees or to have employees interact on topics of interest to them outside the work sphere. However, the employees may not even know that these various groups exist. Again, the group association component 160 can identify these groups that match the profiles and add the individuals to the various groups that match the profile. In some approaches, the employee is not added immediately, but is sent a message indicating that their profile matches specific groups and requesting that they confirm their desire to join a particular group. In some approaches the employee may be automatically joined to some groups and need to confirm their membership in other groups.

New groups can be added to the system at any time. These groups are added to the list of groups 165 that are maintained by the system. When these new groups are created the creator can provide information on the profiles of the individuals who should be members of the group. For example, the creator can indicated that the group is for soccer fans. In this instance the group association component 160 will identify profiles in the private social network 120 having features that indicated the individual is a soccer fan. For each new group created within the private social network 120 the group association component 160 can identify individuals who are candidates for the group and either add them automatically or send invitations to these individuals to join the group based upon the settings or rules for the group.

In some instances the group association component 160 is aware (or becomes aware) of groups that are located on the public social networks 110 that a number of the employees of the organization belong to. These groups may be public groups or may be private groups. When a group is a private group on the public social network 110 other employees who may have an interest in the group may not be able to find the group or even know about its existence. Further, some corporations may have private groups on the public social networks 110 for their employees to use. The group association component 160 can become aware of these groups either by an explicit or direct entry of the group into the list of groups 165 maintained by the group association component 160, or by identifying these groups from the profiles of the employees. When new groups are identified by the group association component 160 the owner of the group may be contacted to determine if the owner wishes to allow the group association component 160 to add individuals to the group. If the owner approves the group may be added to the list of groups 165. In some embodiments, the group is added to the list of groups 165 without waiting for approval from the owner. When the group is located on the public social network 110 and the group association component 160 finds an individual who may want to belong to the group, the group association component 160 can notify the individual of the particular group and provide instructions to the individual as to how to join the group. The individual may receive, for example, an email informing them of the group. In other approaches the owner of the group may be notified that there is an individual in the corporation that they may want to add to the group. The owner can then provide the invitation to the individual inviting them to join the group.

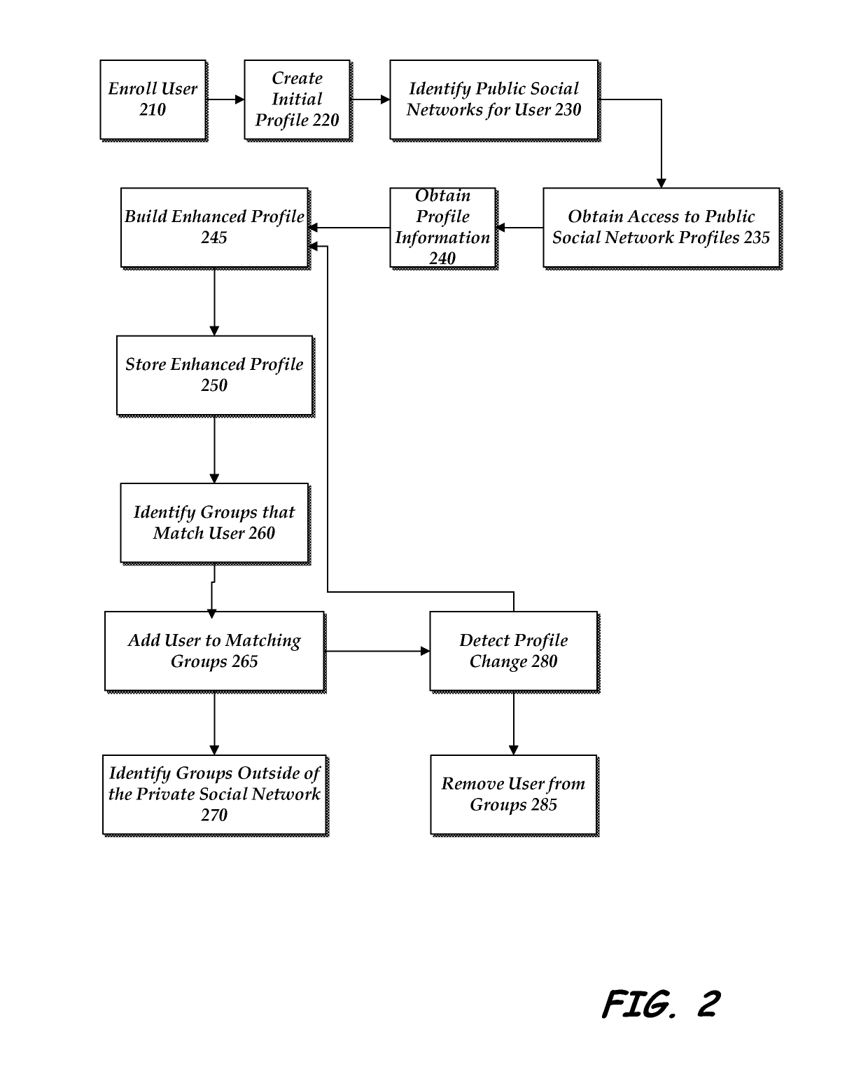

FIG. 2 is a flow diagram illustrating an exemplary approach for generating a profile for an employee and associating them with the proper groups in an organization. The process begins with the enrollment of the employee into the private social network 120. This is illustrated at step 210. The enrollment of the employee can be done by an administrator or human resources personnel when the employee first joins the organization. In some approaches the enrollment of the employee into the system can occur at the time when the person initially applies for a job or first interacts with the organization. In this approach the employee has a profile built within the system, but the profile is not an “active” profile as the person is not an employee or member of the organization at that time. Similarly the profile can be converted from “active” to “inactive” when the employee leaves the organization. Any method can be used to enroll the employee in the private social network 120.

Once the employee has been enrolled in the private social network 120, an initial profile is generated for the employee. This is illustrated at step 220. There are several ways in which this initial profile may be generated for the employee. In one approach the profile is populated by an administrator or other person with information that is related to the employee's role or function within the organization. This information can include their organization (e.g. legal, human resources, development, test, sales, marketing, catering, etc.), their managers, their distance from various others in the organization, office, phone number, etc. In some approaches the profile may be populated with information that was obtained during the hiring process (e.g. from their resume or job application). This information can include their home address, date of birth, marital status, educational status, job history, etc. In some approaches this information is entered manually by the administrator, in other approaches this information may be extracted automatically from data already available, in yet other approaches automatic and manual entries may be used. Following the building of the initial profile the initial profile is stored for later retrieval and updating.

Once the employee's initial profile has been created at step 220, the initial profile may be enhanced and updated to include information contained in profiles maintained by any number of public social networks 110. The enhancement of the profile is illustrates with respect to steps 230-240. In order to obtain this profile information from the public social networks 110 the employee may be presented with an interface where they can enter in information related to the various public social networks 110 that they are members or participate in. This interface can present to the employee a list of known public social networks 110 and ask the employee to provide their credentials to each of the social networks. In other approaches the employee merely provides the information necessary for the profile aggregation component to find their profile on the social networks. In other approaches the employee may tell an administrator or other person the social networks that they are members of and provide the administrator with the information necessary to find their profile on that social network. This is illustrated at step 230.

Depending on the privacy settings of the public social network 110 the profile aggregator 140 may not be able to directly access the employee's profile on the social network. In these approaches the employee may be sent an email or other communication within the private social network 120 or corporate network providing the employee with instructions on how to allow the private social network 120 and the profile aggregator 140 to have access to the profile information on the public social network 110. This is illustrated at step 235. The profile aggregator 140 may have its own profile on the various social networks such that it has the ability to access the profiles of employees once the employee gives permission to the aggregator. When the profile aggregator 140 has a profile on the social network it may send an “invite” to the employee that once accepted by the employee gives the aggregator access to the profile information. In situations where the employee keeps a very private presence on the social network, such as only allowing friends or friends of friends see their profile, the email or other communication to the employee may provide instructions to the employee on how to communicate with the aggregator so that the their profile information can be gathered. Steps 230 and 235 may be repeated for each social network the user is a member. Also if the user later joins a different social network or decides to allow an additional social network profile to be used, these steps can be repeated for the new networks.

Once access has been granted to each of the profiles the profile aggregator 140 gathers each of the profiles. This is illustrated at step 240. At this step the profile aggregator 140 accesses the employee's profile on the social network and brings that profile back into the private network. The profile aggregator 140 uses whatever means have been made available by the public social network 110 to gather profile information. This can include using API's that are exposed by the public social network 110, by viewing the employee's profile on the network and scraping the data from that page, or any other approach that is made accessible to the aggregator to obtain profile information.

The aggregator gathers the profile information and passes the profile information from each of the public social networks 110 to the profile builder 150. The profile builder 150 then begins to build an enhanced version of the employee's initial profile. This is illustrated at step 245. The profile builder 150 may receive each profile from the aggregator as it is obtained, or it may receive all of the profiles that have been obtained all at once. Either approach is equally acceptable in building the enhanced profile. Each profile that is received from the aggregator is noted or annotated with information that indicates the public social network 110 from which it came. This information can be useful in the generation of the enhanced profile for the user as it may indicate certain methods or personality traits of the employee. The profile builder 150 then determines from both the initial profile and the gathered profiles information that is the same as well as information about the employee that may be useful within the private social network 120. This information may be predetermined by the administrator. That is the administrator may have determined that certain pieces of profile information are what they want to gather from the public networks (e.g. only gather residence, interests and family status, but not gather friend lists). In other approaches the profile builder 150 may determine based on the profile information, information that is informative of the person's interests or may be valuable to the organization. The value of this information may be inferred or it may be determined by analyzing other enhanced profiles already maintained by the private social network 120. Each of these pieces of information are added to the employee's initial profile to create the enhanced profile for the employee. The enhanced profile is then stored in the system. This is illustrated at step 250.

Once a number of enhanced profiles have been created and stored, the group association component 160 can then begin to make the associations with the various groups maintained on the private social network 120 to ensure or assist in having the proper memberships present. The group association component 160 can access a particular group from the list of groups 165 and identify the profile features for the individuals who should be members of the group.

Once the group has been selected the group association component 160 takes the profile features that are common to the members of the group and looks for enhanced profiles in the list of profiles for that match the particular profile features of the group. When a profile is identified that matches the features of the members of the group, the group association component 160 determines if the person is already a member of the group. If they are a member of the group, the group association component 160 moves to the next profile that matches. If the person associated with the profile is not a member of the group the group association component 160 determines if they should be added to the group. In some embodiments all persons who match a group profile are determined to be added to the group. However, in other embodiments, a set of rules are applied to determine if the person should be added to the group. For example a person may match the features of the group, but may have a profile feature that excludes them from the group. (e.g. a group interested in soccer, but doesn't include or desire managers, a group that goes hiking, but only wants members who are proximate to the corporate headquarters, etc.). The determination to add the person the group is illustrated at step 260.

Once the determination to add the person to the group has been made at step 260, the group association component 160 adds the person to the group. This is illustrated at step 265. In some approaches the group association component 160 simply adds the person the membership of the group. In some embodiments the group association component 160 checks to see if there are rules for adding the person to the group. For example, the group may have rules associated with it that require that the group owner approve all new members in the group. Another rule may require the individual being added to accept an invitation to join the group. The group association component 160 follows the rules if the rules indicate anything other than adding the person without any further involvement. This can include sending any appropriate notifications to the permitting party. In some embodiments the group association may send notifications to the owner of the group and/or the person being added informing them of the addition of the new member or to request that person's permission to add or be added to the group. It should be noted that different rules can be applied to different groups within the same private social network 120 such that some groups require permission to join while other groups the individual may be added automatically.

The group association component 160 may also be aware of groups that exist on the public social networks 110 that are of interest to the members of the private social network 120. These groups may have been added to the list of groups 165 by their owners at some point in the past, or may have been discovered by the profile builder 150 during the creation of the enhanced profiles. If during the review of the profiles and groups the group association component 160 identifies a group outside the private social network 120 that the user should be added to the group association component 160 can notify the owner and/or the individual that they may be interested in this group. However, because these groups live outside of the private social network 120 the group association component 160 likely cannot add members to the group. The discovery and notification of outside groups is illustrated at step 270.

In some embodiments the process of identify groups for individuals in the private social network 120 can be repeated whenever there is a change in the individual's profile. In this way when something changes, (e.g. the individual is relocated to a different state/country), the system is able to identify new groups that the person may wish to belong to. This can, for example, help assist an individual adjust to a move by finding and connecting them to people in the new location who have similar interest that the person may not have been aware of prior to the move. When a profile change is detected at step 280 the system returns to step 255 and re-performs the associated analysis. Similarly, when a new group is added the addition of the new group may be detected as well at step 280. Additionally, when a profile change is detected at step 280, the group association component 160 can identify groups that the individual currently belongs to that they no longer should be members of. When one of these groups is identified the group association component 160 can remove the individual from the associated group. This is illustrated at step 285. The individual and/or owner may or may not be notified of the removal from the group.

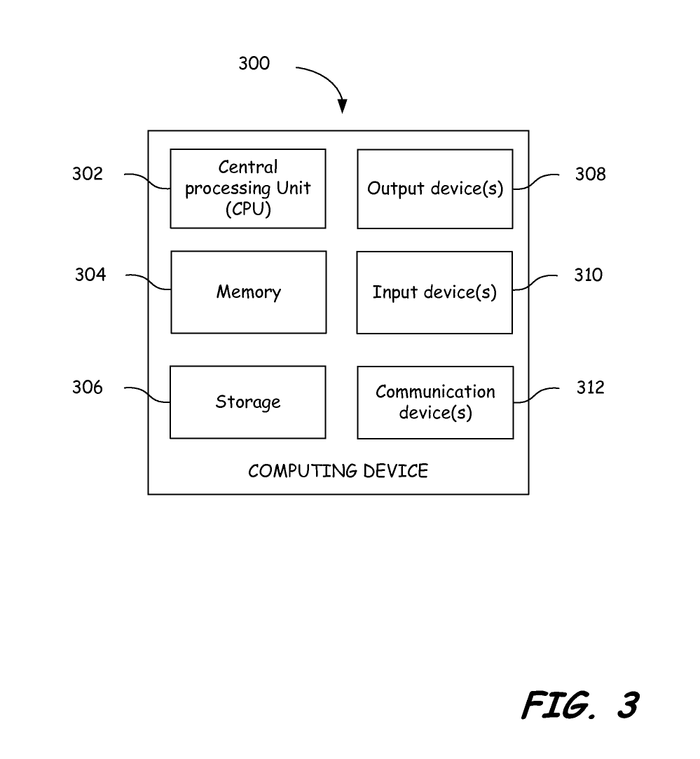

FIG. 3 illustrates a component diagram of a computing device according to one embodiment. The computing device 300 can be utilized to implement one or more computing devices, computer processes, or software modules described herein. In one example, the computing device 300 can be utilized to process calculations, execute instructions, receive and transmit digital signals. In another example, the computing device 300 can be utilized to process calculations, execute instructions, receive and transmit digital signals, receive and transmit search queries, and hypertext, compile computer code, as required by the system of the present embodiments. Further, computing device 300 can be a distributed computing device where components of computing device 300 are located on different computing devices that are connected to each other through network or other forms of connections. Additionally, computing device 300 can be a cloud based computing device.

The computing device 300 can be any general or special purpose computer now known or to become known capable of performing the steps and/or performing the functions described herein, either in software, hardware, firmware, or a combination thereof.

In its most basic configuration, computing device 300 typically includes at least one central processing unit (CPU) 302 and memory 304. Depending on the exact configuration and type of computing device, memory 304 may be volatile (such as RAM), non-volatile (such as ROM, flash memory, etc.) or some combination of the two. Additionally, computing device 300 may also have additional features/functionality. For example, computing device 300 may include multiple CPU's. The described methods may be executed in any manner by any processing unit in computing device 300. For example, the described process may be executed by both multiple CPU's in parallel.

Computing device 300 may also include additional storage (removable and/or non-removable) including, but not limited to, magnetic or optical disks or tape. Such additional storage is illustrated in FIG. 3 by storage 306. Computer storage media includes volatile and nonvolatile, removable and non-removable media implemented in any method or technology for storage of information such as computer readable instructions, data structures, program modules or other data. Memory 304 and storage 306 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 300. Any such computer storage media may be part of computing device 300.

Computing device 300 may also contain communications device(s) 312 that allow the device to communicate with other devices. Communications device(s) 312 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 300 may also have input device(s) 310 such as keyboard, mouse, pen, voice input device, touch input device, etc. Output device(s) 308 such as a display, speakers, printer, etc. may also be included. All these devices are well known in the art and need not be discussed at length. Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A system for identifying individuals for membership in groups maintained on a private social network comprising:
a profile store having a plurality of profiles for a plurality of user of the private social network;
a profile builder configured to take an existing profile for at least one user on the private social network and enhance the existing profile with features from a profile obtained from at least one profile associated with the at least one user on at least one public social network;
a list of groups associated with the private social network, each group in the list of groups having at least one membership feature, the at least one membership feature corresponding to at least one feature that may be found in a user profile; and
a group association module configured to identify at least one group from the list of groups in the private social network that the at least one user should be a member of and to add the at least one user to the at least one group, wherein the at least one group includes a membership feature that is derived from the at least one profile for the user on the public social network.

2. The system of claim 1 further comprising:
a profile aggregator configured to obtain profile information for the at least one user from at least one profile associated with the at least one user from at least one public social network.

3. The system of claim 1 wherein the group association module is further configured to generate a request to an owner of the at least one group indicating that a potential new member has been identified.

4. The system of claim 1 wherein the group association module is further configured to generate a request to the at least one user indicating that the group association module has identified at least one group for the at least one user to join.

5. The system of claim 1 wherein the profile builder accesses at least two different profiles for the at least one user.

6. The system of claim 5 wherein at least one of the at least two different profiles is on a different public social network.

7. The system of claim 5 wherein at least two of the at least two different profiles are on the same public social network.

8. The system of claim 1 wherein the group association module is configured to automatically add the at least one user to the at least one group.

9. The system of claim 1 wherein the group association component is further configured to recommend to an administrator to create a new group in the list of groups when a number of users in profile store exceeds a threshold number of users that have a common profile feature and there is no group in the list of groups that matches the common profile feature.

10. The system of claim 1 wherein the list of groups includes groups on the at least one public social network.

11. The system of claim 9 wherein the group association component is further configured to add a new group to the list of groups, when the new group appears in more than a threshold number of user profiles, wherein the new group is a group located on the at least one public social network.

12. A method of identifying users for membership in groups associated with a private social network, comprising:
creating an initial profile for a user on the private social network;
enhancing the initial profile by obtaining profile information for the user from a profile associated with the user on a public social network;
identifying at least one group from a list of groups associated with the private social network that has a membership feature that matches at least one feature of the enhanced profile;
adding the user to the at least one group; and
updating the enhanced profile for the user to indicate that the user is a member of the at least one group.

13. The method of claim 12 further comprising:
enrolling the user in the private social network.

14. The method of claim 12 wherein creating an initial profile further comprises entering information related to employment of the user in an organization owning the private social network.

15. The method of claim 12 further comprising:
detecting a change in the enhanced profile; and
identifying at least one group in the list of groups that has a membership feature that matches the change in the enhanced profile.

16. The method of claim 15 further comprising:
determining based on the change in the enhanced profile if the user is a member of a group having membership features that do not match the enhanced profile; and
removing the user as a member of the group when there is no match.

17. The method of claim 12 further comprising:
receiving credentials for the user on the at least one public network; and
accessing a profile for the user on the at least one public network.

18. The method of claim 12 further comprising:
prior to adding the user to the at least one group, receiving permission from an owner of the at least one group to allow the addition of the user.

19. The method of claim 12 further comprising:
prior to adding the user to the at least one group, receiving permission from the user to add the user to the at least one group.

20. A computer readable storage medium having computer executable instructions that when executed by at least one computing device causes the computer device to: create an initial profile for a user on the private social network;
identify at least one profile for the user on at least one public social network;
obtain access to the at least one profile on the at least one public social network from the user;
enhance the initial profile by integrating the at least one profile with the initial profile to create an enhanced profile;
identify at least one group from a list of groups associated with the private social network that has a membership feature that matches at least one feature of the enhanced profile;
add the user to the at least one group; and
update the enhanced profile for the user to indicate that the user is a member of the at least one group.
